(19) United States
(12) Patent Application Publication
(10) Pub. No.: US 2010/0060668 A1
(43) Pub. Date: Mar. 11, 2010

(54) METHOD AND DEVICE FOR CONTROLLING BRIGHTNESS OF DISPLAY ELEMENT

(76) Inventor: Kuo-Hua CHEN, Hsichih (TW)

Correspondence Address: Muncy, Geissler, Olds & Lowe, PLLC, P.O. BOX 1364, FAIRFAX, VA, 22038-1364, US

(21) Appl. No.: 12/365,580

(22) Filed: Feb. 4, 2009

(30) Foreign Application Priority Data
Sep. 5, 2008 (TW) 97134255

(51) Int. Cl. G09G 5/10

(52) U.S. Cl. 345/690

(57) ABSTRACT

A method and device for controlling the backlight brightness of a display element are provided. The display method utilizes horizontal scan frequency and vertical scan frequency of an image to obtain a display mode of the image by referring to a scan-frequency list. When the display mode of the image is a first mode, set the backlight module of the display element to a first brightness, which makes the display element display the image with the first brightness. When the display mode of the image is a second mode, set the backlight module of the display element to a second brightness, which makes the display element display the image with the second brightness, wherein the display element displays the image more brightly with the second brightness than with the first brightness.

### RELATED APPLICATIONS

This application claims priority to Taiwan Application Serial Number 97134255, filed Sep. 5, 2008, which is herein incorporated by reference.

### BACKGROUND OF THE INVENTION

1. Field of the Invention

The present invention relates to methods and devices for controlling brightness of a display element, and more particularly, to a method and device for setting brightness of a display element automatically.

2. Description of the Prior Art

Owing to advancement of technology, display elements are applied in more and more areas. Given integration of audio/video interfaces, for example, High Definition Multimedia Interface (HDMI), display elements nowadays are compatible with video mode (for example, 480i, 480p, 720p, 1080i, 1080p) and PC mode (for example, VGA, SVGA, XGA, SXGA, UXGA). Display elements are set to different display modes for displaying an image so as for users to use the display elements for achieving various goals. A user sets a display element to image mode when the display element is used for entertainment, because the display element configured for entertainment has to be set to high brightness so as to enhance contrast. A user sets a display element to PC mode when the display element is connected to a personal computer, because the display element connected to a personal computer has to be set to low brightness such that the computer screen is not harsh to the eye. However, existing display elements are incapable of setting brightness according to a display mode, and in consequence users stress their eyes with inappropriate brightness of a display element set to an inappropriate display mode when different display modes are available for selection by the users during usage of the display element.

Hence, there is a need for a display method whereby a display module operable at different display modes is set to their respective degrees of brightness.

### SUMMARY OF THE INVENTION

In view of this, the present invention is directed to a display method for setting brightness of a display module according to a display mode of an image.

According to a preferred embodiment of the present invention, a display method comprises the steps of:

(1) obtaining a horizontal scan frequency and a vertical scan frequency of an image;

(2) referring to frequencies set forth in a scan-frequency list according to the horizontal scan frequency and the vertical scan frequency of the image so as to obtain the display mode of the image;

(3) setting brightness of a display module to a first brightness when the display mode of the image is a first mode, thereby allowing the display module to display the image with the first brightness; and

(4) setting brightness of the display module to a second brightness when the display mode of the image is a second mode, thereby allowing the display module to display the image with the second brightness, wherein the display module displays the image more brightly with the second brightness than with the first brightness.

According to a preferred embodiment of the present invention, a display device comprises a display module, an image signal receiver, and an image processing unit. The image signal receiver receives an image signal. The image processing unit comprises an image mode determinator. The image mode determinator refers to frequencies set forth in a scan-frequency list according to a horizontal scan frequency and a vertical scan frequency of an image signal so as to determine the display mode of the image signal. Brightness of the display module is set to a first brightness upon determination that the display mode of the image signal is a first mode. Brightness of the display module is set to a second brightness upon determination that the display mode of the image signal is a second mode. The display module is brighter with the second brightness than with the first brightness.

According to another preferred embodiment of the present invention, the display method further comprises the steps of:

(1) displaying an image on a display module;

(2) determining whether a scan mode of the image is an interlace scan mode; and

(3) increasing brightness of the display module upon determination that the scan mode of the image is the interlace scan mode.

According to yet another preferred embodiment of the present invention, the display device comprises a display module, an image signal receiver, and an image processing unit. The image signal receiver receives an image signal. The image processing unit comprises a scan mode determinator. The scan mode determinator determines whether a scan mode of the image signal is an interlace scan mode, thereby increasing brightness of the display module upon determination that the scan mode of the image signal is the interlace scan mode.

### BRIEF DESCRIPTION OF THE DRAWINGS

The above and other objectives, features, advantages, and preferred embodiments of the present invention will be best understood by referring to the following detailed description of the accompanying drawings, wherein:

FIG. 1 is a flow chart of a display method according to a preferred embodiment of the present invention;

FIG. 2 is a functional block diagram of a display module 200;

FIG. 3 is a functional block diagram of a display device according to another preferred embodiment of the present invention;

FIG. 4 is a flow chart of a display method according to yet another preferred embodiment of the present invention; and

FIG. 5 is a functional block diagram of a display device according to yet another preferred embodiment of the present invention.

### DETAILED DESCRIPTION OF THE EMBODIMENTS

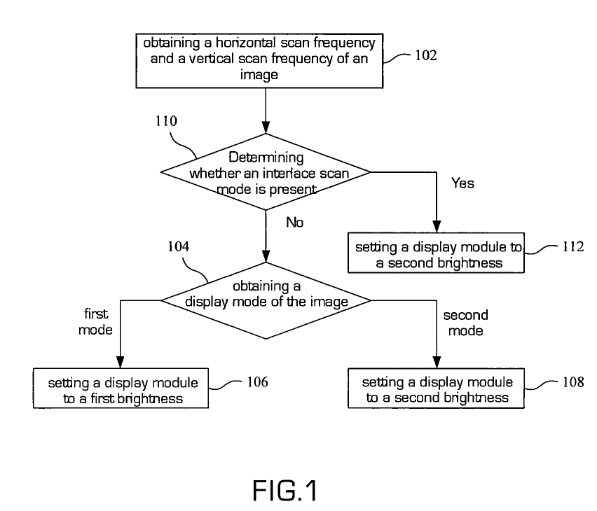

Referring to FIG. 1, which is a flow chart of a display method according to a preferred embodiment of the present invention, the display method enables brightness of a display module to be set according to a display mode. Specifically speaking, the display method relates to a method of controlling backlight brightness of a display element. Unless otherwise specified, the sequence of the steps described in the preferred embodiments of the present invention is subject to change as needed, wherein the change includes concurrence occurring in whole or in part, and a change in precedence. The display method comprises the steps of:

(1) obtaining a horizontal scan frequency and a vertical scan frequency of an image; (Step 102)

(2) obtaining a display mode of the image, according to the horizontal scan frequency and the vertical scan frequency of the image; (Step 104)

(3) setting brightness of a display module to a first brightness when the display mode of the image is a first mode, thereby allowing the display module to display the image with the first brightness; and (Step 106)

(4) setting brightness of the display module to a second brightness when the display mode of the image is a second mode, thereby allowing the display module to display the image with the second brightness, wherein the display module displays the image more brightly with the second brightness than with the first brightness. (Step 108)

Specifically speaking, regarding Step 104, a combination of a horizontal scan frequency and a vertical scan frequency varies with a display mode, and thus the display mode of the image can be obtained according to a horizontal scan frequency and a vertical scan frequency. Furthermore, at Step 104, the display mode of the image can be obtained by referring to a scan-frequency list, wherein the scan-frequency list may be stored in a memory. In practice, Step 104 involves comparing the horizontal scan frequency and vertical scan frequency with frequencies set forth in the scan-frequency list so as to obtain the display mode of the image. For instance, reference to a scan-frequency list reveals that, given a horizontal scan frequency of 15.73 kHz and a vertical scan frequency of 59.94 Hz, the display mode features 480/60i at image mode.

In this preferred embodiment, the first mode is exemplified by a PC mode, the second mode by a video mode, and the display module by a display element. In most cases, a user would be closer to the display element at the PC mode but farther from the display element at the image mode. Hence, at the PC mode, brightness of the display element is set to the first brightness which is dimmed, so as to prevent the glare of said display element from dazzling the user's eyes when he or she is close to the display element. On the other hand, at the image mode, brightness of the display element is set to the second brightness which is bright, so as to render the display element colorful.

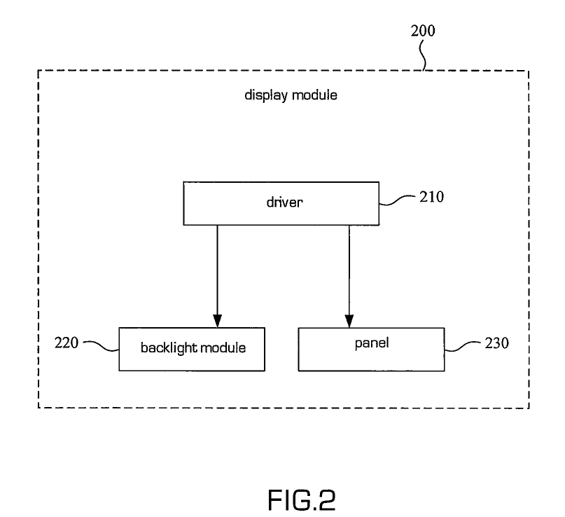

Referring to FIG. 2, which is a functional block diagram of a display module 200, the display module 200 comprises a driver 210, a backlight module 220, and a panel 230. The display module 200 is a liquid crystal display (LCD) element. The driver 210 drives the backlight module 220 and the panel 230 respectively. For instance, referring to FIG. 1 and FIG. 2, if the display method illustrated with FIG. 1 is applied to the display module 200, Step 106 and Step 108 involve adjusting brightness of the backlight module 220 of the display module 200 with the driver 210 of the display module 200. Specifically speaking, the driver 210 drives brightness of the backlight module 220 to the first brightness at Step 106 and drives brightness of the backlight module 220 to the second brightness at Step 108. In the situation where another display element of a different type functions as the display module, brightness of the display module is adjusted by a brightness parameter at Step 106 and Step 108. Accordingly, the display method enables brightness of a display module to be set according to a display mode.

The interlace scan mode is a scan mode unique to the image mode, and thus it is feasible to determine that the display mode of an image is the image mode upon determination that the scan mode of the image is the interlace scan mode. Hence, the display method comprises the steps of:

(1.1) determining, before obtaining the display mode of the image, whether a scan mode of the image is an interlace scan mode; and (Step 110).

(1.2) setting brightness of the display module to the second brightness when the scan mode of the image is the interlace scan mode, thereby allowing the display module to display the image with the second brightness. (Step 112)

Hence, the display method also enables the display mode of an image to be determined at the scan mode thereof.

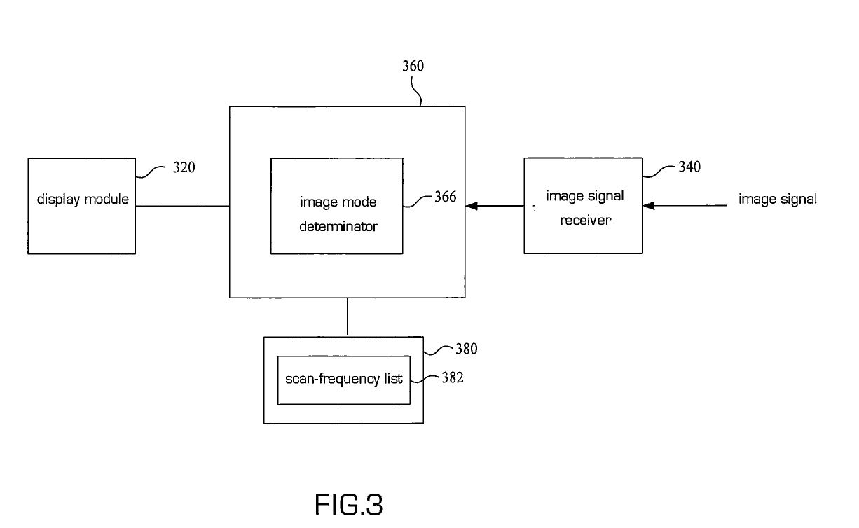

Referring to FIG. 3, which is a functional block diagram of a display device according to another preferred embodiment of the present invention, the display device comprises a display module 320, an image signal receiver 340, and an image processing unit 360. The image signal receiver 340 is configured to receive an image signal. The image processing unit 360 comprises an image mode determinator 366. The image mode determinator 366 is configured to refer to a scan-frequency list 382 according to horizontal scan frequency and vertical scan frequency of an image signal, so as to determine a display mode of the image signal. The scan-frequency list 382 is stored in a memory 380. Brightness of the display module 320 is set to a first brightness when the display mode of the image signal is a first mode. Brightness of the display module 320 is set to a second brightness when the display mode of the image signal is a second mode. The display module 320 is brighter with the second brightness than with the first brightness. Hence, the display module 320 is set to different degrees of brightness depending on a display mode.

In practice, the image signal receiver 340 is designed to work on a specific image transmission interface (for example, HDMI, but not limited to this kind of image signal). The image transmission interface is High Definition Multimedia Interface (HDMI), Digital Visual Interface (DVI), DisplayPort, or any other image transmission interface. The image processing unit 360 is implemented by an image scaler that functions as a microprocessor control unit (MCU). The scan-frequency list 382 is stored in a memory 380.

Moreover, in the situation where the display module 320 is a liquid crystal display (LCD) element, a backlight module of the display module 320 is adjusted by driving a display driving module thereof. In the situation where the display module 320 is a non-liquid crystal display (non-LCD) element, brightness of the display module 320 is adjusted by adjusting a brightness parameter thereof.

For instance, the first mode is exemplified by a PC mode and the second mode by a video mode. Normally, the video mode requires higher brightness than the PC mode, so as to render the display module colorful. Hence, at the PC mode, if brightness of the display element is set to that of the video mode (for example, one for watching TV), users who are usually close to the display module will find the display element glaring.

Hence, the display method of the present invention enables brightness of a display module to be set according to display modes of various image signals, so as to meet users' needs, such as ease of use.

Furthermore, the interlace scan mode is a scan mode unique to the image mode, and thus it is feasible for the image mode determinator 366 to determine whether the scan mode of an image is the interlace scan mode upon determination that the second mode of the display device is the image mode. Upon determination that the scan mode of an image is the interlace scan mode, brightness of the display module 320 is set to the second brightness, thereby allowing the display module 320 to display the image with the second brightness. Hence, if the display mode for an image is the image mode, the display device will identify the display mode for the image without referring to a scan-frequency list.

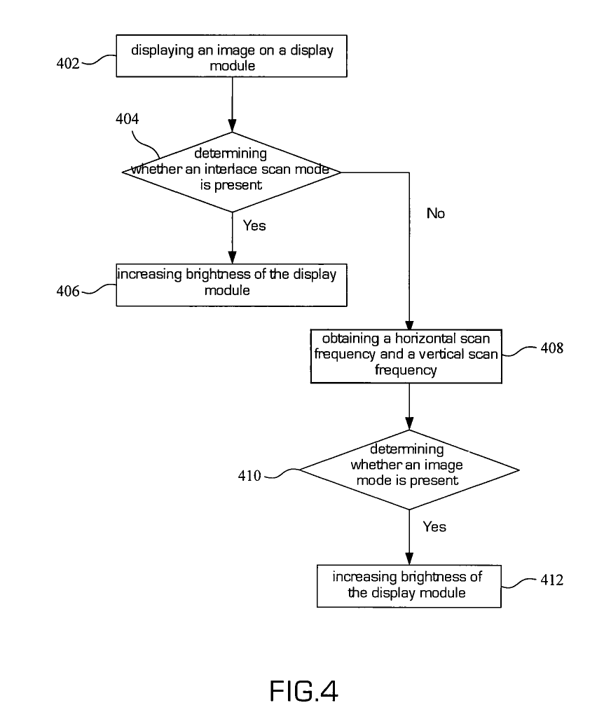

FIG. 4 is a flow chart of a display method according to yet another preferred embodiment of the present invention. The interlace scan mode is a scan mode unique to the image mode, and thus it is feasible for the display method of the present invention to control brightness of the display element by determination of the scan mode. Unless otherwise specified, the sequence of the steps described in the preferred embodiments of the present invention is subject to change as needed, wherein the change includes concurrence occurring in whole or in part, and a change in precedence. The display method comprises the steps of:

(1) displaying an image on a display module; (Step 402)

(2) determining whether a scan mode of the image is an interlace scan mode; and (Step 404)

(3) increasing brightness of the display module upon determination that the scan mode of the image is the interlace scan mode. (Step 406)

In the situation where the display method is applied to a liquid crystal display (LCD) element, Step 406 involves driving a driver of the display module so as to adjust brightness of a backlight module and thereby increase brightness of the liquid crystal display element. Where the display method is applied to a non-liquid crystal display (non-LCD) element, Step 406 increases brightness of the non-liquid crystal display element by using a brightness parameter.

Therefore, the display method of the present invention increases brightness of a display element when the scan mode of an image is interlace scan mode such that the enhanced brightness of the display element is fit for an image watched by a user at the image mode.

Moreover, an image whose scan mode is not the interlace scan mode can have the display mode being the image mode. Hence, at the time when the scan mode of an image is not the interlace scan mode, the display method comprises the steps of:

(4) obtaining a horizontal scan frequency and a vertical scan frequency of an image; (Step 408)

(5) determining whether a display mode of the image is an image mode according to the horizontal scan frequency and the vertical scan frequency; (Step 410)

(6) increasing brightness of the display module upon determination that the display mode of the image is the image mode. (Step 412)

Regarding Step 410, a combination of a horizontal scan frequency and a vertical scan frequency varies with a display mode, and thus the display mode of the image can be obtained according to a horizontal scan frequency and a vertical scan frequency. Specifically speaking, at Step 410, the display mode of the image can be obtained by referring to a scan-frequency list stored in a memory. In practice, Step 410 involves comparing the horizontal scan frequency and vertical scan frequency with frequencies set forth in the scan-frequency list so as to obtain the display mode of the image.

For instance, reference to (comparison with) different frequencies set forth in a scan-frequency list reveals that, given a horizontal scan frequency of 15.73 kHz and a vertical scan frequency of 59.94 Hz, the display mode features 480/60i at image mode. Hence, with the display method of the present invention, brightness of the display element can be increased when the display mode of an image is the image mode.

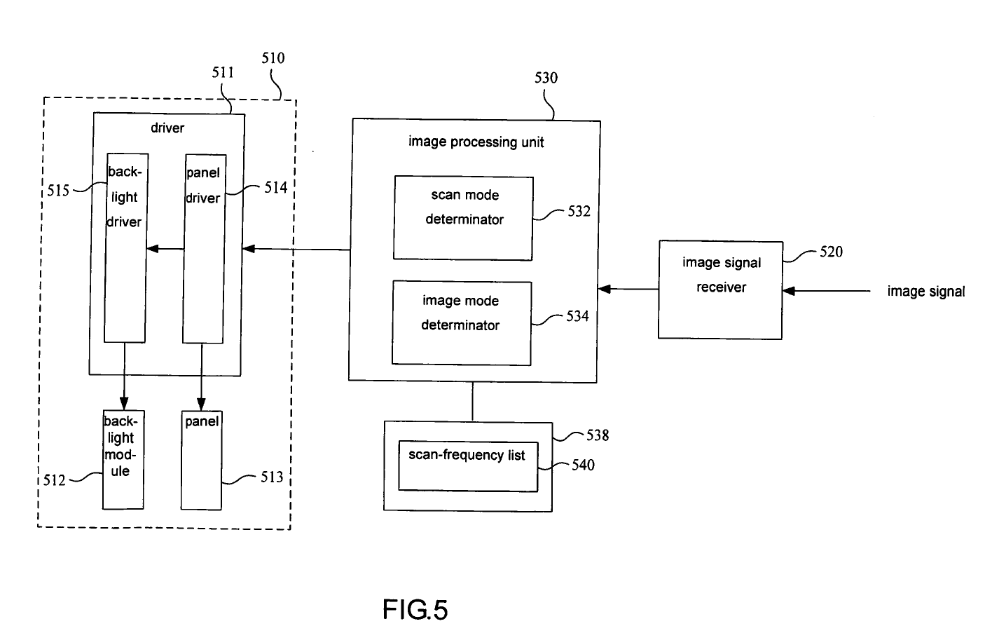

Referring to FIG. 5, which is a functional block diagram of a display device according to yet another preferred embodiment of the present invention, the display device comprises a display module 510, an image signal receiver 520, and an image processing unit 530. The image signal receiver 520 receives an image signal. The image processing unit 530 comprises a scan mode determinator 532. The scan mode determinator 532 determines the type of the display mode of the received image signal. Specifically speaking, the scan mode determinator 532 determines whether the scan mode of the image signal is the interlace scan mode, and increases brightness of the display module 510 upon determination that the scan mode of the image signal is the interlace scan mode.

In practice, the image signal receiver 520 is designed to work on a specific image transmission interface (for example, HDMI, but not limited to this kind of image signal). The image transmission interface is High Definition Multimedia Interface (HDMI), Digital Visual Interface (DVI), DisplayPort, or any other image transmission interface. The image processing unit 530 is implemented by a microprocessor control unit (MCU).

Hence, the display device features enhancement of brightness of the display module 510 when the scan mode of an image is the interlace scan mode such that the enhanced brightness of the display module 510 fits the image mode of the image.

Furthermore, an image signal whose scan mode is not the interlace scan mode can have the display mode being the image mode. Hence, the image processing unit 530 of the display device comprises an image mode determinator 534. The image mode determinator 534 refers to a scan-frequency list 540 according to a horizontal scan frequency and a vertical scan frequency of the image signal upon determination that the scan mode of the image signal is not the interlace scan mode, so as to determine whether the display mode of the image signal is the image mode. The scan-frequency list 540 is stored in a memory 538. Brightness of the display module 510 is increased upon determination that the display mode of the image signal is the image mode.

In the situation where the display module 510 is a liquid crystal display (LCD) element, the display module 510 comprises a driver 511, a backlight module 512, and a panel 513. The driver 511 drives the backlight module 512 and the panel 513. Specifically speaking, the driver 511 comprises a panel driver 514 and a backlight driver 515. The display module 510 adjusts the way of displaying image brightness; specifically speaking, brightness of the backlight module 512 is driven by the panel driver 514 and the backlight driver 515 such that the enhanced brightness of the display module 510 fits the image mode.

Although the invention has been disclosed with the preferred embodiments, the preferred embodiments are not intended to restrict the scope of the present invention. It will be understood that various changes and modifications apparent thereto may be effected by those skilled in the art in the foregoing preferred embodiments without departing from the spirit and scope of the present invention. Hence, the scope of the present invention should be defined by the appended claims.

What is claimed is:

1. A display method, comprising the steps of:
obtaining a horizontal scan frequency and a vertical scan frequency of an image;
obtaining a display mode of the image according to the horizontal scan frequency and the vertical scan frequency;
setting brightness of a display module to a first brightness when the display mode of the image is a first mode, thereby allowing the display module to display the image with the first brightness; and
setting brightness of the display module to a second brightness when the display mode of the image is a second mode, thereby allowing the display module to display the image with the second brightness, wherein the display module displays the image more brightly with the second brightness than with the first brightness.

2. The display method of claim 1, wherein the obtaining the display mode of the image comprises the step of:
referring to a scan-frequency list according to the horizontal scan frequency and the vertical scan frequency so as to obtain the display mode of the image.

3. The display method of claim 1, further comprising the steps of:
determining, before obtaining the display mode of the image, whether a scan mode of the image is an interlace scan mode; and
setting brightness of the display module to the second brightness when the scan mode of the image is the interlace scan mode, thereby allowing the display module to display the image with the second brightness.

4. The display method of claim 1, wherein the setting brightness of the display module to the first brightness comprises the step of:
driving brightness of a backlight module of the display module to the first brightness with a driver of the display module.

5. The display method of claim 1, wherein the setting brightness of the display module to the second brightness comprises the step of:
driving brightness of a backlight module of the display module to the second brightness with a driver of the display module.

6. A display device, comprising:
a display module;
an image signal receiver for receiving an image signal; and
an image processing unit, comprising:
means for referring to a scan-frequency list according to a horizontal scan frequency and a vertical scan frequency of the image signal, so as to determine a display mode of the image signal, setting brightness of the display module to a first brightness upon determination that the display mode of the image signal is a first mode, and setting brightness of the display module to a second brightness upon determination that the display mode of the image signal is a second mode, wherein the display module is brighter with the second brightness than with the first brightness.

7. A display method, comprising the steps of:
displaying an image on a display module;
determining whether a scan mode of the image is an interlace scan mode; and
increasing brightness of the display module upon determination that the scan mode of the image is the interlace scan mode.

8. The display method of claim 7, further comprising the steps of:
obtaining a horizontal scan frequency and a vertical scan frequency of the image;
determining whether a display mode of the image is an image mode according to the horizontal scan frequency and the vertical scan frequency upon determination that the scan mode of the image is not the interlace scan mode; and
increasing brightness of the display module upon determination that the display mode of the image is the image mode.

9. The display method of claim 8, wherein the determining whether the display mode of the image is the image mode comprises the step of:
referring to a scan-frequency list according to the horizontal scan frequency and the vertical scan frequency so as to determine whether the display mode of the image is the image mode.

10. A display device, comprising:
a display module;
an image signal receiver for receiving an image signal; and
an image processing unit, comprising:
means for determining whether a scan mode of the image signal is an interlace scan mode and increasing brightness of the display module upon determination that the scan mode of the image signal is the interlace scan mode.

11. The display device of claim 10, wherein the image processing unit further comprises:
means for referring to a scan-frequency list according to a horizontal scan frequency and a vertical scan frequency of the image signal upon determination that the scan mode of the image signal is not the interlace scan mode, so as to determine whether a display mode of the image signal is an image mode and increase brightness of the display module upon determination that the display mode of the image signal is the image mode.
